(19) United States
(12) Patent Application Publication
(10) Pub. No.: US 2025/0325948 A1
(43) Pub. Date: Oct. 23, 2025

(54) Stirrer Arrangement

(71) Applicant: KSB SE & Co. KGaA, Frankenthal (DE)

(72) Inventors: Juergen GEINITZ, Frankenthal (DE); Ralf HAHN, Frankenthal (DE); Andreas MICHELMANN, Frankenthal (DE); Matthias MOHR, Frankenthal (DE)

(21) Appl. No.: 18/868,267

(22) PCT Filed: May 17, 2023
(86) PCT No.: PCT/EP2023/063343

§ 371 Date: Nov. 22, 2024

(30) Foreign Application Priority Data
May 25, 2022 (DE) 10 2022 113 278.1

(51) Int. Cl. B01F 27/07; B01F 27/113

(52) U.S. Cl. CPC B01F 27/071; B01F 27/113

(57) ABSTRACT

A stirrer arrangement including a shaft, a drive device, a hub body, and at least two blades. The at least two blades are arranged on the hub body and extend radially from the hub body relative to the rotational axis. Each of the at least two blades has a foot that is configured to fasten on the hub body and, along a radial extent, a leading-edge region and a trailing-edge region opposite the leading-edge region. The hub body has a wall in which depressions are provided to receive the blade feet. On an outside of the wall, recesses are provided which reach up to a part portion of the depressions. In a vicinity of the foot, each blade has an extent which protrudes beyond the foot, is formed by the leading-edge region and protrudes into the respective recess.

### CROSS REFERENCE TO RELATED APPLICATION

This application claims priority under 35 U.S.C. § 119 from German Patent Application No. 10 2022 113 278.1, filed May 25, 2022, the entire disclosure of which is herein expressly incorporated by reference.

### BACKGROUND

The disclosure concerns a stirrer arrangement having a shaft which is drivable in rotation about a rotational axis, a drive device which is arranged at a first shaft end for driving the shaft, a hub body which is arranged rotationally fixedly on the shaft at a second shaft end, at least two blades which are arranged on the hub body and extend substantially radially from the hub body relative to the rotational axis, wherein each of the blades has a foot for fastening on the hub body and, along the substantially radial extent, a leading edge region and a trailing edge region opposite the leading edge region.

Such stirrers, also known as flow accelerators, are used in many sectors, e.g. for recirculation of activated sludge in sludge basins, for conveying rainwater, floodwater, surface and polder water, and for generating flow in bodies of water. The stirrers achieve a good flow guidance in the corresponding basins or systems in order to fulfil the respective process object, e.g. good mixing of multiple phases.

The stirrers are usually arranged on a freestanding stirrer stand as known from EP 2 328 676 A1, or fixed to a basin wall by means of a guidance and holding pipe assembly, as known for example from EP 2 659 959 A1. EP 2 689 831 A1 describes a stirrer device arranged on the container cover.

Stirrer arrangements are also known in which only the propeller with the shaft is arranged in the basin, while the drive is placed outside the basin, i.e. in a horizontal or vertical installation position in the case of long-shaft stirrers.

EP 3 066 188 A1 discloses a stirrer device in which each stirrer blade is attached to a receiver device, wherein multiple receiver devices form an axle receiver in which a hub arranged on the driveshaft can be inserted and screwed thereto.

Because of the separate production of hub body and propeller blades, as described in EP 3 066 188 A1, a gap occurs at the contact face between the two components. Any dirt particles and fibres which may be present in the inflow can penetrate into the gap and settle there. In particular long fibres which adhere to the rotating components in this region may have negative effects on the performance and operating reliability of the stirrer.

Particularly severe contamination may in the end require unscheduled maintenance or cleaning processes, which are usually associated with failures and hence costs for the plant operator.

### SUMMARY

The present disclosure is based on the object of alleviating or even fully eliminating the defects of the devices known from the prior art. In concrete terms, it is an object of the present disclosure to provide a stirrer arrangement in which the above-mentioned contamination mechanisms are reduced and the efficiency increased.

This object is achieved by a stirrer with the features of claim 1, according to which the hub body has a wall in which depressions are provided for receiving the blade feet, and on the outside of the wall, recesses are provided which reach up to a part portion of the depressions, wherein, in the vicinity of the foot, each blade has an extent which protrudes beyond the foot, is formed substantially by the leading edge region and protrudes into the respective recess.

The recess is set back from the front edge contour of the propeller profile and, in interaction with three-dimensional front edge design, allows dirt particles and fibres to slide off. The recess furthermore generates secondary flows or eddies which suppress the adhesion of dirt in the gap region.

In an advantageous embodiment, the hub body comprises a substantially cup-like base body. This allows very simple assembly and dismantling of the entire stirring member, if necessary however also of the individual blades.

To ensure that the interior of the hub body remains largely free of fibres, the hub body is closed by a cover at its free end.

For simple assembly and dismantling, the hub body furthermore comprises a bottom element with a shaft receiver in which the shaft can be inserted and connected to the hub body by means of a screw connection.

Furthermore, the bottom element is formed substantially conical, wherein the shaft receiver has a substantially cylindrical form. The conical design of the bottom element in particular substantially simplifies the assembly or dismantling of the blades when the hub body is installed.

Further advantages, features and effects of the present disclosure arise from the following figures. In the drawings:

### BRIEF DESCRIPTION OF THE DRAWINGS

FIG. 1 shows a perspective illustration of the stirrer according to the disclosure,

FIG. 2 shows a longitudinal section through the hub body,

FIG. 3 shows a perspective, detail illustration of the hub body, and

FIG. 4 shows the hub body of the stirrer according to the disclosure with blades arranged thereon.

### DETAILED DESCRIPTION

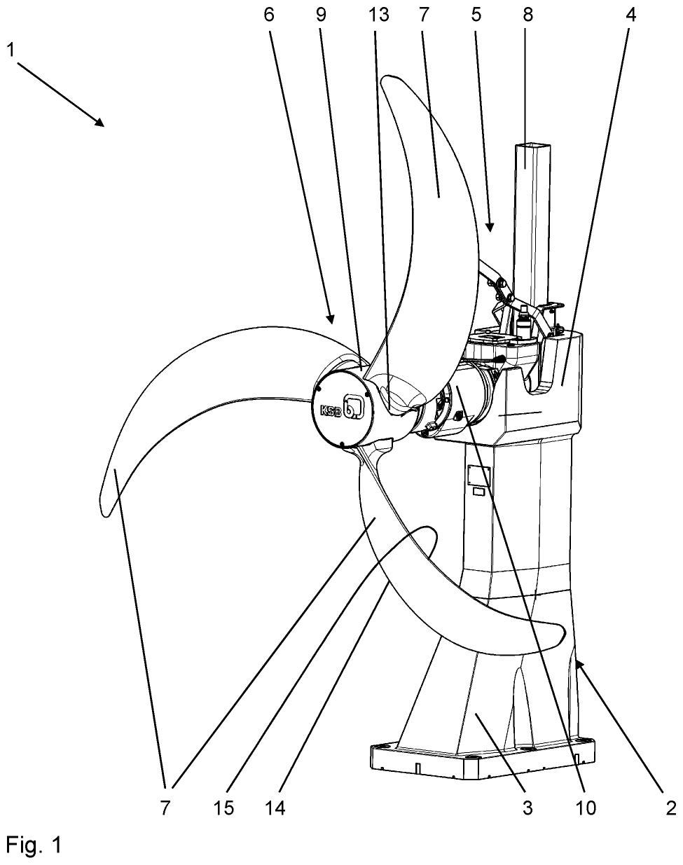

FIG. 1 shows a stirrer assembly 1 with a stirrer stand 2, which in this embodiment variant is produced as an integral concrete or mineral casting and has a foot part 3 and a receiving part 4. The contour of the receiving part 4 is configured such that it can receive a submersible motor stirrer 5 and fix this in its working position.

The submersible motor stirrer 5 has a stirring member 6, here configured as a propeller with three blades 7. A guide member 8, only partially illustrated in FIG. 1, protrudes beyond the stirrer stand 2. This guide member 8, here configured as a steel tube with square cross-section, serves purely to guide the submersible motor stirrer 5 during lowering or withdrawal.

The propeller or stirring member 6 comprises a hub body 9 on which the blades 7 are arranged.

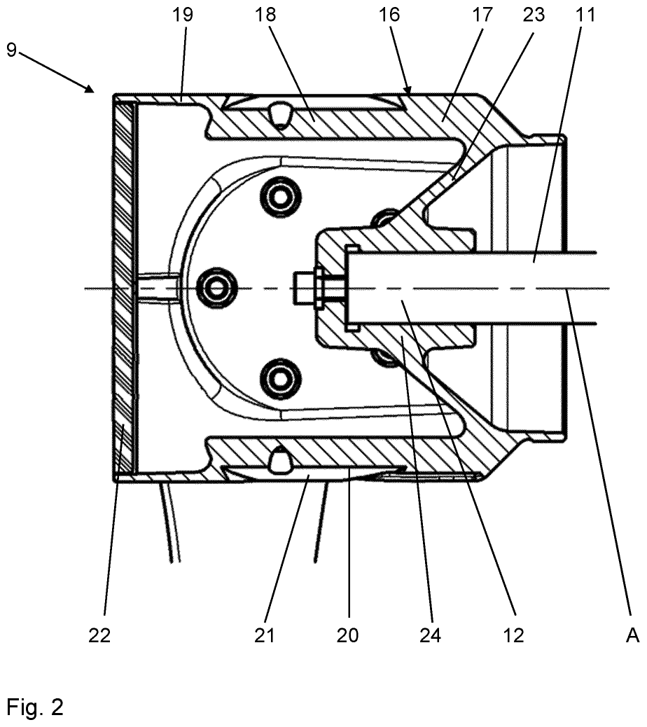

The stirrer 1 has a drive device 10 with a motor and gear mechanism, not shown in detail. A shaft, not shown in FIG. 2, is connected by a first shaft end (not shown) to the drive device and can be driven in rotation about a rotational axis A.

FIG. 1 shows a stirrer arrangement 1 with a stirrer stand 2 which is produced as an integral concrete casting. The object of the disclosure may however also be used in stirrer arrangements in which only the propeller with shaft is arranged in the basin, while the drive is placed outside the basin.

As furthermore evident from FIG. 2, which shows the hub body 9 in a longitudinal section, the hub body 9 is arranged rotationally fixedly on the shaft 11 at a second shaft end 12. At least two blades 7-three are shown in FIG. 1-are arranged on the hub body 9 and extend from the hub body 9 substantially radially relative to the rotational axis A. Each blade 7 comprises a foot 13 for fastening to the hub body 9. The blades 7 have, substantially in the radial extent, a leading edge region 14 and a trailing edge region 15 opposite the leading edge region 14. The stirring member 6 rotates counterclockwise viewed from the drive device 10.

As evident from FIG. 2, the hub body 9 comprises a substantially cup-like base body 16 with a wall 17. The base body 16 or wall 17 has a first body portion 18 with reduced inner diameter, and a second body portion 19 with enlarged inner diameter.

In the first body portion 18, the hub body 9, in particular the wall 17, has several depressions 20 corresponding to the number of blades 7. The depressions 20 in turn each have a contact face 21 on which the blade foot 13, received in the depression, comes to rest. The contact faces 21 are formed lying substantially parallel to the rotational axis A. At the free end of the second body portion 19, the hub body 9, in particular the cup-like base body 16, may be closed by a cover 22.

The hub body, in particular the base body 16, comprises a bottom element 23 with a shaft receiver 24, in which a shaft 11 can be inserted and connected to the hub body 9 by means of a screw connection. The base body 16 coaxially surrounds the shaft receiver 24, via which the hub body 9 can be arranged on or fastened to the shaft 11. The bottom element 23 is formed substantially conical, wherein the shaft receiver 24 formed integrally with the bottom element 23 has a substantially cylindrical form.

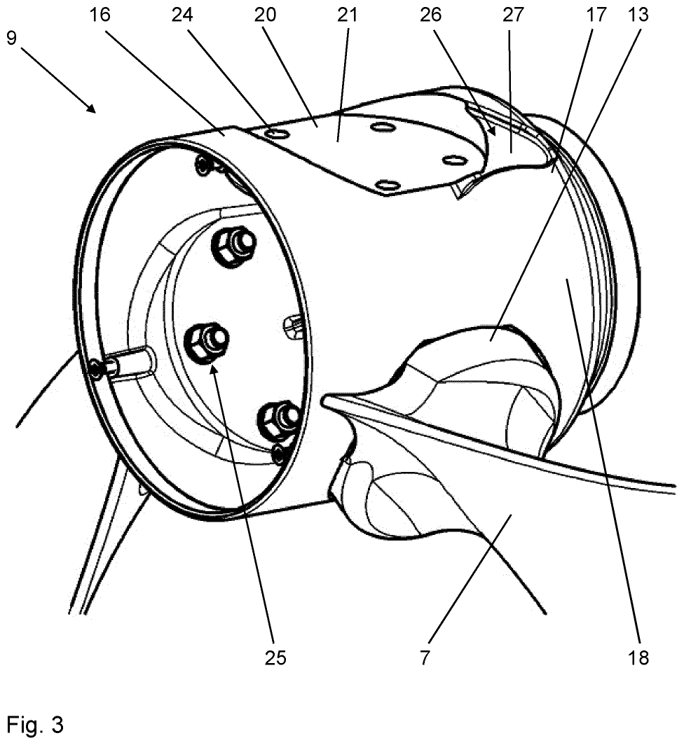

It is clear from FIG. 3 that in the region of the depressions 20, a plurality of passage bores 24 are provided which extend from the contact face 21 into the interior of the hub body 9. By means of connecting elements 25, the blades 7 are arranged on or fastened to the base body 16 of the hub body 9.

The connecting means 25 may for example comprise screws or threaded bolts with threaded nuts. The screws or threaded bolts extend through the passage bores 24 and are screwed into corresponding threaded bores (not shown) in the blade feet 13.

In the region of the first body portion 18, the hub body 9, in particular the base body 16, has a recess 26 on the outside of the wall 17 which reaches up to a part of the depression 20. The recess 26 has a contact face 27.

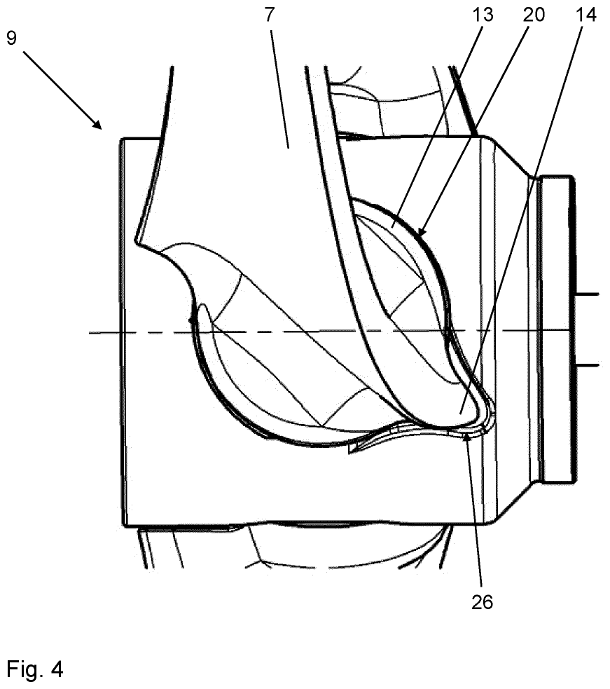

FIG. 4 shows the side view of the hub body 9 with blades 7 arranged thereon. Each of the blade feet 13 is let into one of the depressions 20. In the vicinity of the foot 13, the blade 7 has an extent protruding beyond the foot 13 and formed substantially by the leading edge region 14. The extent formed by the leading edge region 14 protrudes into the recess 26. A part of the leading edge region 14 here comes to rest on the contact face 27 shown in FIG. 3

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-5. (canceled)

6. A stirrer arrangement comprising:
a shaft which is drivable in rotation about a rotational axis;
a drive device which is arranged at a first shaft end configured to drive the shaft;
a hub body which is arranged rotationally fixedly on the shaft at a second shaft end; and
at least two blades which are arranged on the hub body and extend radially from the hub body relative to the rotational axis, wherein
each of the at least two blades has a foot that is configured to fasten on the hub body and, along a radial extent, a leading-edge region and a trailing-edge region opposite the leading-edge region,
the hub body has a wall in which depressions are provided to receive the blade feet,
on an outside of the wall, recesses are provided which reach up to a part portion of the depressions, and
in a vicinity of the foot, each blade has an extent which protrudes beyond the foot, is formed by the leading-edge region and protrudes into the respective recess.

7. The stirrer arrangement as claimed in claim 6, wherein the hub body comprises a cup-like base body.

8. The stirrer arrangement as claimed in claim 7, wherein the hub body is closed by a cover at its free end.

9. The stirrer arrangement as claimed in claim 8, wherein the hub body comprises a bottom element with a shaft receiver.

10. The stirrer arrangement as claimed in claim 9, wherein the bottom element is conical, and the shaft receiver has a cylindrical shape.
